(19) United States
(12) Patent Application Publication
(10) Pub. No.: US 2012/0112560 A1
(43) Pub. Date: May 10, 2012

(54) THERMAL CONTROL POWER DEVICE

(76) Inventor: Jui-Hsiung Wu, Taipei (TW)

(21) Appl. No.: 12/940,041

(22) Filed: Nov. 4, 2010

(51) Int. Cl. H01H 47/26

(52) U.S. Cl. 307/117

(57) ABSTRACT

A thermal control power device has a thermal control circuit which includes a power module for getting and dealing with an AC input voltage, a control module, and a switch module having an electromagnetic relay and a driving circuit. The control module includes a microcontroller having a plurality of specific temperature value of constant temperatures therein, a power unit regulating an output voltage of the power module and providing a work voltage for the microcontroller, a temperature setting switch making choice of one of the constant temperatures, and a thermal detector detecting an environment temperature under which an external electric appliance works. The microcontroller compares the environment temperature with the constant temperature and then sends out corresponding control signals. The driving circuit controls switch states of the electromagnetic relay according to the control signals so as to further automatically control the electric appliance on-off.

### BACKGROUND OF THE INVENTION

1. Field of the Invention

The present invention generally relates to a power device, and more particularly to a thermal control power device.

2. The Related Art

Power devices, such as plugs, are generally employed to be connected with a power supply so as to make the power supply provide power for electric appliances. However, the electric appliances, such as electric fans and warmers, often need to work under specific environment temperature. If the power devices are always connected with the power supply with power switches of the electric appliances not yet turned off, then a circuit will always be formed to continually consume a current so that results in waste of power. In addition, the electric appliances may be subjected to sustained high environment temperature due to long-term use. As a result, the electric appliances are apt to be damaged by the high environment temperature. So the users often need to pull out all the power devices or turn off the power switches of the electric appliances, when going out or before having a rest. It is inconvenient to use. So a power device having a thermal control function is required.

### SUMMARY OF THE INVENTION

An object of the present invention is to provide a thermal control power device which includes an insulating housing, a plurality of conductive terminals fastened in the insulating housing and partially stretching out of the insulating housing for connecting with an AC power supply, and a thermal control circuit disposed in the insulating housing. The thermal control circuit includes a power module connected with the conductive terminals for getting and dealing with an AC input voltage to output a proper output voltage, a switch module having an electromagnetic relay and a driving circuit, and a control module which includes a microcontroller having a plurality of specific temperature value of constant temperatures preset therein, a power unit regulating the output voltage of the power module and then providing a work voltage for the microcontroller, a temperature setting switch mounted in the insulating housing for making choice of one of the constant temperatures, and a thermal detector detecting an environment temperature under which an external electric appliance works. The microcontroller compares the detected environment temperature with the selected constant temperature and then sends out corresponding control signals. The driving circuit controls switch states of the electromagnetic relay according to the control signals from the microcontroller, so as to further automatically control the external electric appliance on-off. Wherein the switch states of the electromagnetic relay rest with whether the output voltage of the power module is provided thereon or not under the control of the driving circuit.

As described above, the thermal control power device of the present invention drives the driving circuit to control the switch states of the electromagnetic relay and further automatically switch on/off the external electric appliance, by means of utilizing the temperature setting switch to make choice of one constant temperature, utilizing the thermal detector to detect the environment temperature, and then utilizing the microcontroller to compare the detected environment temperature and the selected constant temperature so as to output corresponding control signals to the driving circuit. Therefore, even if users forget to shut off the electric appliances by hand, the thermal control power device of the present invention still can avoid waste of power or damage of the electric appliances due to long-term use.

### BRIEF DESCRIPTION OF THE DRAWINGS

The present invention will be apparent to those skilled in the art by reading the following description, with reference to the attached drawings, in which:

FIG. 1 is a view of a thermal control power device according to an embodiment of the present invention;

FIG. 2 is a block diagram of a thermal control circuit of the thermal control power device of FIG. 1;

FIG. 3 is a circuitry of a power module and a switch module of the thermal control circuit of FIG. 2; and

FIG. 4 is a circuitry of a control module of the thermal control circuit of FIG. 2.

### DETAILED DESCRIPTION OF THE EMBODIMENT

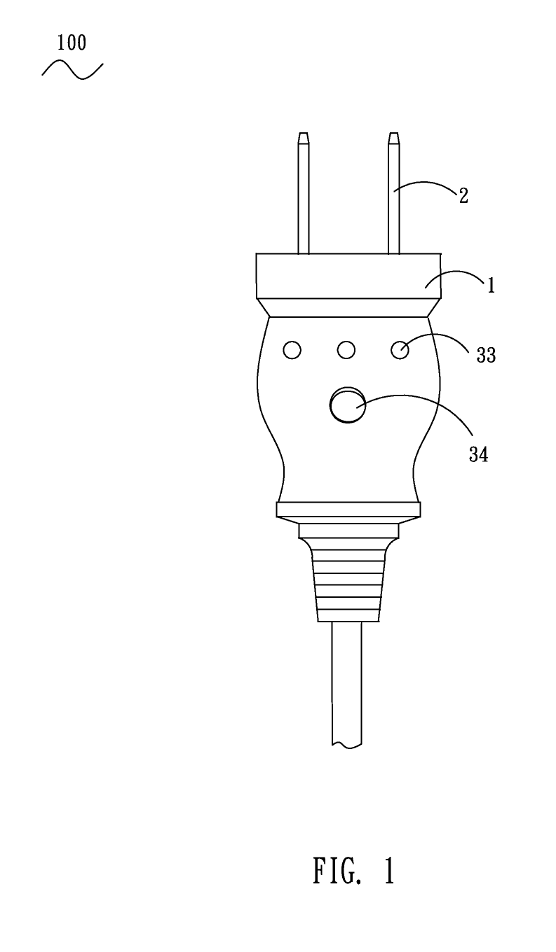

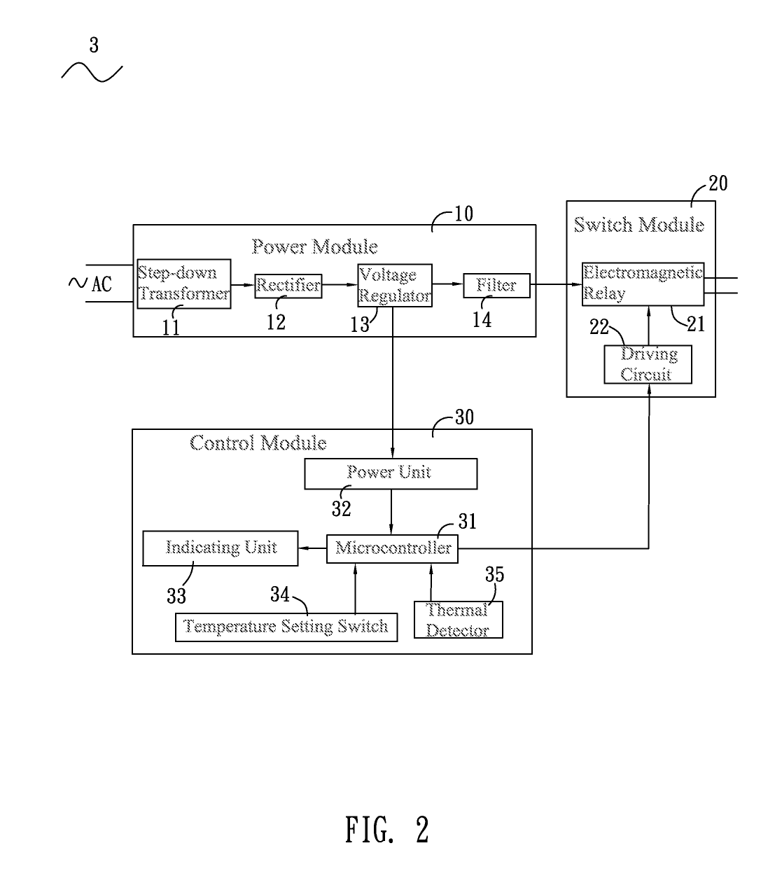

With reference to FIG. 1 and FIG. 2, a thermal control power device 100 according to an embodiment of the prevent invention includes an insulating housing 1, a plurality of conductive terminals 2 and a thermal control circuit 3. In this embodiment, the insulating housing 1 is an ordinary plug housing. The conductive terminals 2 are embedded in the insulating housing 1 and partially stretch out of the insulating housing 1 for connecting with an AC power supply. The thermal control circuit 3 is disposed in the insulating housing 1 and includes a power module 10, a switch module 20 and a control module 30.

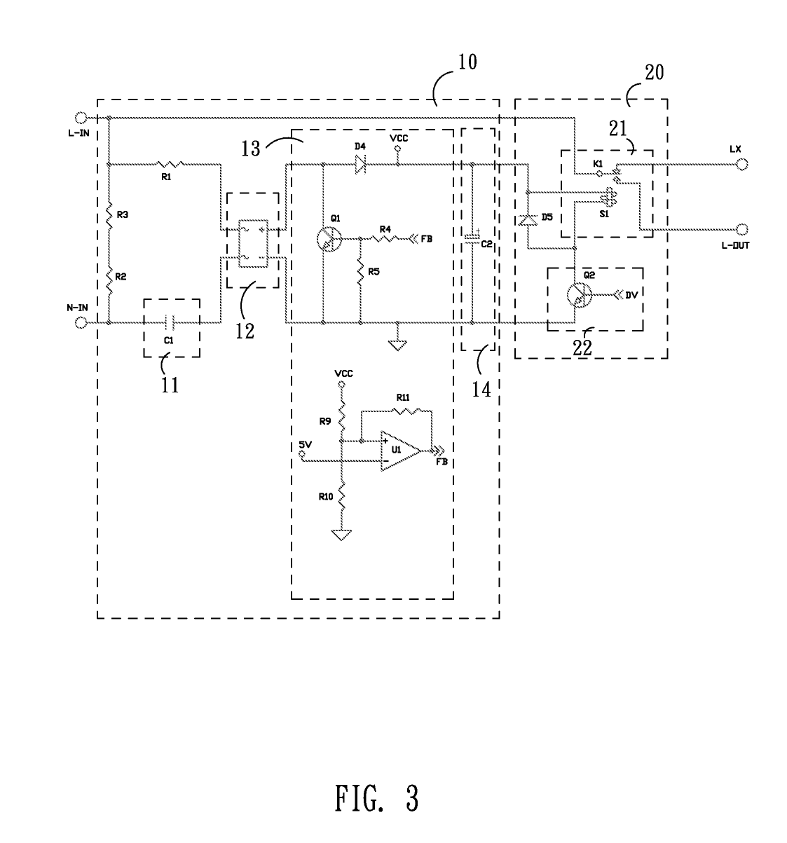

Referring to FIG. 2 and FIG. 3, the power module 10 is connected with the conductive terminals 2 for getting an AC input voltage. The power module 10 includes a step-down transformer 11, a rectifier 12, a voltage regulator 13 and a filter 14 which are successively connected together. The voltage regulator 13 has a comparator U1 and a first transistor Q1 of which the collector and the emitter are respectively connected to positive and negative output ports of the rectifier 12. The negative output port of the rectifier 12 is further connected to ground. The non-inverting input of the comparator U1 is connected between a first voltage-dividing resistor R9 and a second voltage-dividing resistor R10 connected in series. Another two terminals of the first and the second voltage-dividing resistors (R9, R10) are respectively connected to a positive output terminal VCC of the power module 10 and ground. The inverting input of the comparator U1 is connected with a standard voltage which will be defined later. The output of the comparator U1 is connected with the base of the first transistor Q1 so as to control switch states of the first transistor Q1 according to a voltage compared result of the non-inverting input with the inverting input. When the non-inverting input is at a higher voltage than the inverting input, namely a potential between the first voltage-dividing resistor R9 and the second voltage-dividing resistor R10 after an output voltage of the positive output terminal VCC is divided by the first and the second voltage-dividing resistors R9, R10 is higher than the standard voltage, the output of the comparator U1 outputs a positive voltage signal to control the first transistor Q1 connected. At this time, the positive output port of the rectifier 12 is short connected to ground, and the power module 10 has no voltage output. When the non-inverting input is at a lower voltage than the inverting input, the output of the comparator U1 outputs a negative voltage signal to control the first transistor Q1 disconnected. At this time, the power module 10 has a normal voltage output.

Referring to FIG. 2 and FIG. 3 again, the switch module 20 includes an electromagnetic relay 21 and a driving circuit 22. The driving circuit 22 has a second transistor Q2 of which the collector is connected to the positive output terminal VCC of the power module 10 through a directive diode D5, the emitter is connected to ground and the base is connected with the control module 30. The electromagnetic relay 21 is composed of a control system S1 parallel-connected to the directive diode D5, and a switch system K1 of which the stationary contact is connected with one of the conductive terminals 2, and one movable contact is drawn forth as an output for connecting with an external electric appliance, wherein switch states of the switch system K1 are controlled according to whether the output voltage of the power module 10 is output on the control system S1 or not.

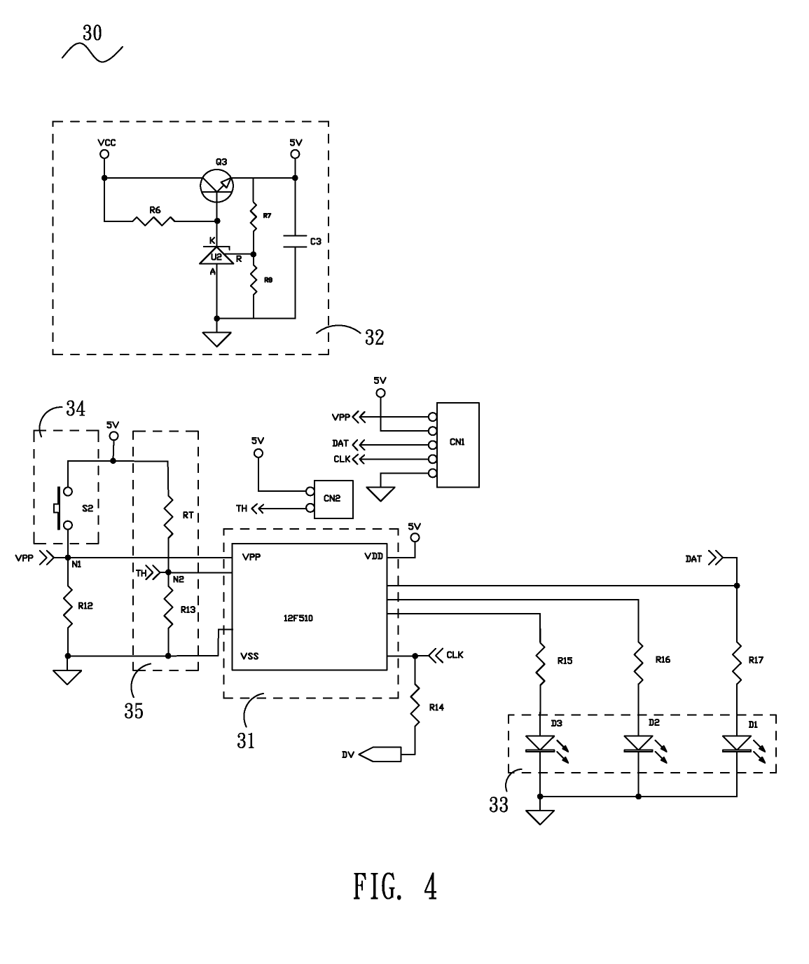

Referring to FIG. 1, FIG. 2 and FIG. 4, the control module 30 includes a microcontroller 31, a power unit 32, an indicating unit 33, a temperature setting switch 34 and a thermal detector 35. The power unit 32 is connected between the power module 10 and the microcontroller 31 for regulating and filtering the output voltage of the power module 10 so as to provide a work voltage for the microcontroller 31. The power unit 32 includes a third transistor Q3 of which the collector is connected to the positive output terminal VCC of the power module 10, the base is on one hand connected to ground through a zener diode U2, and on the other connected to the collector through a first resistor R6, and the emitter successively passes through a second resistor R7 and a third resistor R8 to be connected to ground. The connection of the second resistor R7 and the third resistor R8 is drawn forth to be connected with a reference electrode R of the zener diode U2. The emitter of the third transistor Q3 is further connected with the microcontroller 31 so as to provide the work voltage for the microcontroller 31, wherein the work voltage is no other than the above mentioned standard voltage.

The indicating unit 33 includes a plurality of light-emitting diodes of which each is connected with an indicating port of the microcontroller 31 and mounted in the insulating housing 1, wherein the microcontroller 31 has a plurality of specific temperature value of constant temperatures preset therein, and each indicating port of the microcontroller 31 corresponds to one of the constant temperatures. The temperature setting switch 34 is mounted in the insulating housing 1 and connected with the microcontroller 31 for making choice of one constant temperature so as to correspondingly control the light-emitting diodes of the indicating unit 33 by means of the microcontroller 31. When the temperature setting switch 34 makes choice of one constant temperature, there is a first signal N1—reflecting a standard temperature—transmitted to the microcontroller 31. The thermal detector 35 includes a thermal resistor RT of which one terminal is connected with the emitter of the third transistor Q3, and the other terminal is connected to ground through a voltage-dividing resistor R13. The connection of the thermal resistor RT and the voltage-dividing resistor R13 is further drawn forth to be connected with a signal input port of the microcontroller 31, so as to transmit a second signal N2—reflecting a varying environment temperature—for the microcontroller 31. A control port of the microcontroller 31 is connected with the base of the second transistor Q2 of the driving circuit 22, for controlling switch states of the second transistor Q2 by means of dealing with the first signal N1 and the second signal N2, namely comparing the selected constant temperature with the varying environment temperature.

Referring to FIGS. 1-4, when the thermal control power device 100 is connected with the AC power supply, the light-emitting diodes light by turns under the control of the microcontroller 31. When the temperature setting switch 34 makes choice of one of the constant temperatures preset in the microcontroller 31 and further sends a first signal N1 to the microcontroller 31, the microcontroller 31 on one hand drives the light-emitting diode corresponding to the selected constant temperature by the temperature setting switch 34 to keep lighting and other light-emitting diodes to be gone out, and on the other hand controls the second transistor Q2 of the driving circuit 22 in a connected state. After the second transistor Q2 is connected, the output voltage of the power module 10 is provided on the control system Si of the electromagnetic relay 21. Therefore, the switch system K1 is closed, and the external electric appliance is switched on. Simultaneously, the thermal resistor RT of the thermal detector 35 detects an environment temperature under which the electric appliance works, and sends a second signal N2 to the microcontroller 31. Then the microcontroller 31 deals with the first signal N1 and the second signal N2. When the environment temperature is higher than the selected constant temperature by the temperature setting switch 34, the second transistor Q2 of the driving circuit 22 is disconnected under the control of the microcontroller 31. As a result, the switch system K1 is opened due to the status of no voltage provided on the control system S1. So the electric appliance is shut off automatically.

As described above, the thermal control power device 100 of the present invention drives the driving circuit 22 to control the switch states of the electromagnetic relay 21 and further automatically switch on/off the external electric appliance, by means of utilizing the temperature setting switch 34 to make choice of one constant temperature, utilizing the thermal detector 35 to detect the environment temperature, and then utilizing the microcontroller 31 to deal with the first signal N1 and the second signal N2 so as to output corresponding control signals to the driving circuit 22. Therefore, even if users forget to shut off the electric appliances by hand, the thermal control power device 100 of the present invention still can avoid waste of power or damage of the electric appliances due to long-term use.

The foregoing description of the present invention has been presented for purposes of illustration and description. It is not intended to be exhaustive or to limit the invention to the precise form disclosed, and obviously many modifications and variations are possible in light of the above teaching. For example, the insulating housing 1 may be an ordinary socket housing or adapter housing. Such modifications and variations that may be apparent to those skilled in the art are intended to be included within the scope of this invention as defined by the accompanying claims.

What is claimed is:

1. A thermal control power device, comprising:
an insulating housing;
a plurality of conductive terminals fastened in the insulating housing and partially stretching out of the insulating housing for connecting with an AC power supply; and
a thermal control circuit disposed in the insulating housing and including:
a power module connected with the conductive terminals for getting and dealing with an AC input voltage to output a proper output voltage;
a control module including a microcontroller which has a plurality of specific temperature value of constant temperatures preset therein, a power unit for regulating the output voltage of the power module and then providing a work voltage for the microcontroller, a temperature setting switch mounted in the insulating housing for making choice of one of the constant temperatures, and a thermal detector detecting an environment temperature under which an external electric appliance works, the microcontroller comparing the detected environment temperature with the selected constant temperature and then sending out corresponding control signals; and
a switch module having an electromagnetic relay and a driving circuit, the driving circuit controlling switch states of the electromagnetic relay according to the control signals from the microcontroller, so as to further automatically control the external electric appliance on-off, wherein the switch states of the electromagnetic relay rest with whether the output voltage of the power module is provided thereon or not under the control of the driving circuit.

2. The thermal control power device as claimed in claim 1, wherein the thermal detector includes a thermal resistor of which one terminal is connected with the power unit and the other terminal is connected to ground through a voltage-dividing resistor, the connection of the thermal resistor and the voltage-dividing resistor is further drawn forth to be connected with the microcontroller.

3. The thermal control power device as claimed in claim 1, wherein the control module further includes an indicating unit which has a plurality of light-emitting diodes respectively connected with indicating ports of the microcontroller and mounted in the insulating housing, each indicating port of the microcontroller corresponds to one of the constant temperatures, when the temperature setting switch makes choice of one of the constant temperatures, the microcontroller drives the light-emitting diode corresponding to the selected constant temperature to keep lighting and other light-emitting diodes to be gone out.

4. The thermal control power device as claimed in claim 1, wherein the power unit includes a transistor of which the collector is connected with a positive output terminal of the power module, the base is on one hand connected to ground through a zener diode, and on the other hand connected to the collector through a first resistor, and the emitter successively passes through a second resistor and a third resistor to be connected to ground, the connection of the second resistor and the third resistor is drawn forth to be connected with a reference electrode of the zener diode, the emitter of the transistor is further connected with the microcontroller to provide the work voltage for the microcontroller.

5. The thermal control power device as claimed in claim 1, wherein the driving circuit of the switch module has a transistor of which the collector is connected to a positive output terminal of the power module through a directive diode and the emitter is connected to ground, the electromagnetic relay comprises a control system parallel-connected to the directive diode and a switch system connected between one of the conductive terminals and the external electric appliance, the microcontroller of the control module is connected with the base of the transistor so as to control switch states of the transistor and further control whether the output voltage of the power module is provided on the control system or not.

6. The thermal control power device as claimed in claim 1, wherein the power module includes a step-down transformer, a rectifier, a voltage regulator and a filter which are successively connected together.

7. The thermal control power device as claimed in claim 1, wherein the insulating housing is a plug housing, a socket housing or an adapter housing.
